(19) United States
(12) Patent Application Publication
(10) Pub. No.: US 2009/0307594 A1
(43) Pub. Date: Dec. 10, 2009

(54) Adaptive User Interface

(76) Inventors: Timo Kosonen, Tampere (FI); Kai Havukainen, Lempaala (FI); Jukka Holm, Tampere (FI); Antti Eronen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/227,313

(22) PCT Filed: May 12, 2006
(86) PCT No.: PCT/IB2006/001932

§ 371 Date: Feb. 18, 2009

(51) Int. Cl. G06F 3/16; G06F 17/00

(52) U.S. Cl. 715/727; 700/94

(57) ABSTRACT

A method comprising: obtaining music information that defines at least one characteristic of audible music; and controlling changes to an appearance of a graphical user interface using the music information.

### FIELD OF THE INVENTION

Embodiments of the present invention relate to an adaptive user interface. In particular, some embodiments relate to methods, systems, devices and computer programs for changing an appearance of a graphical user interface in response to music.

### BACKGROUND TO THE INVENTION

It is now common for people to listen to music using digital electronic devices such as dedicated music players or multi-functional devices that have music playing as an available function.

Such devices typically have a user interface that enables a user of the device to control the device. Some devices have a graphical user interface (GUI).

Digital music is a growth business, but it is extremely competitive. It would therefore be desirable to increase the value associated with digital music and/or digital music player so that they are more desirable and consequently more valuable.

### BRIEF DESCRIPTION OF THE INVENTION

According to an embodiment of the invention there is provided a method comprising: obtaining music information that defines at least one characteristic of audible music; and controlling changes to an appearance of a graphical user interface using the music information.

According to another embodiment of the invention there is provided a system comprising: a display for providing a graphical user interface; and a processor operable to obtain music information that defines at least one characteristic of audible music and operable to control changes to an appearance of the graphical user interface using the music information while the music is audible.

According to a further embodiment of the invention there is provided a computer program for obtaining music information that defines at least one characteristic of audible music; and controlling changes to an appearance of a graphical user interface using the music information.

According to another embodiment of the invention there is provided a method comprising: storing a data structure that defines at least how a graphical user interface changes and changing with successive beats of audible music, the appearance of the graphical user interface using the data structure.

### BRIEF DESCRIPTION OF THE DRAWINGS

For a better understanding of the present invention reference will now be made by way of example only to the accompanying drawings in which:

FIG. 1 schematically illustrates a system for controlling a graphical user interface (GUI);

FIGS. 2A, 2B and 2C illustrate a GUI that changes appearance in response to the tempo of the beats in audible music;

FIG. 3A and FIG. 3B illustrates how a size of a graphical menu item may vary when the audible music has, respectively, a slow tempo and a faster tempo; and

FIG. 4 illustrates a method of generating a GUI that changes in response to audible music.

### DETAILED DESCRIPTION OF EMBODIMENTS OF THE INVENTION

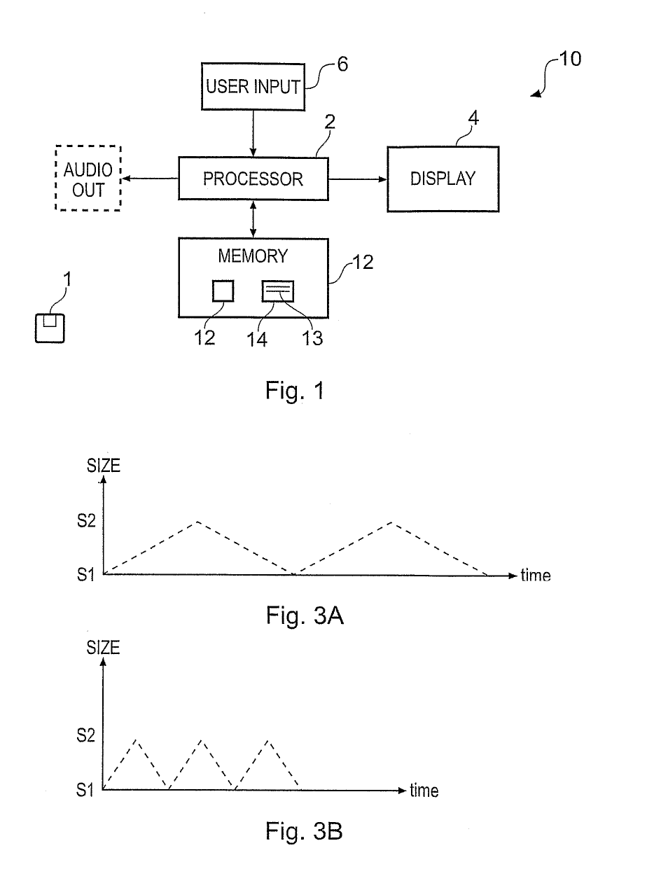

FIG. 1 schematically illustrates a system 10 for controlling a graphical user interface (GUI). The system comprises: a processor 2, a display 4, a user input device 6 and a memory 12 storing computer program instructions 14, and a GUI database 16.

The processor 2 is arranged to write to and read from the memory 4 and to control the output of the display 8. It receives user input commands from the user input device 6.

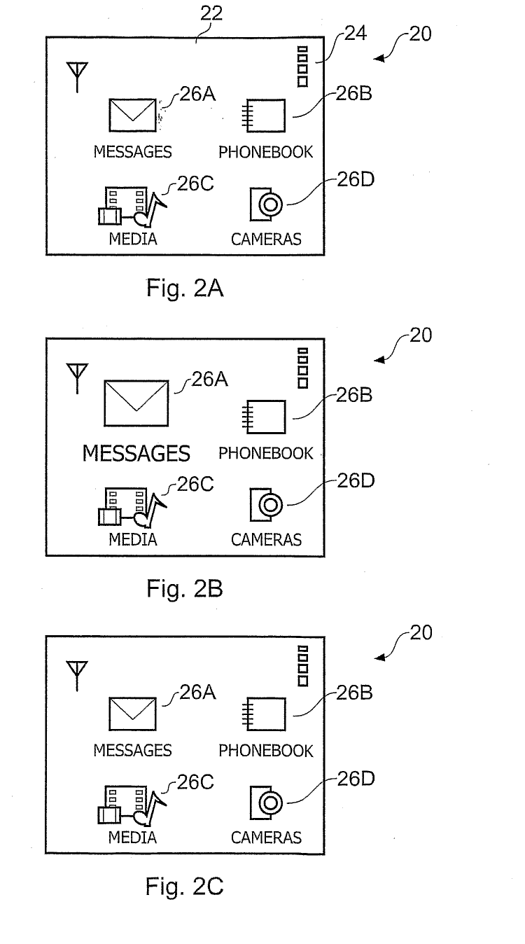

The computer program instructions 6 define a graphical user interface software application. The computer program instructions 6, when loaded into the processor 2, provide the logic and routines that enables the system 10 to perform the method illustrated in FIGS. 2, 3 and/or 4.

The computer program instructions 6 may arrive at the electronic device via an electromagnetic carrier signal or be copied from a physical entity 1 such as a computer program product, a memory device or a record medium such as a CD-ROM or DVD.

The system 10 will typically be part of an electronic device such as a personal digital assistant, a personal computer, a mobile cellular telephone, a personal music player etc.

The system 10 may also be used as a music player. In this embodiment, a music track may be stored in the memory 4. Computer program instructions when loaded into the processor 2, enable the functionality of a music player as is well known in the art. The music player processes the music track and produces an audio control signal which is provided to an audio output device 8 to play the music. The audio output device may be, for example, a loudspeaker or a jack for headphones. The music player is responsible for the audio playback, i.e., it reads the music track and renders it to audio.

FIGS. 2A, 2B and 2C illustrate a GUI 20 that changes appearance in response to and in time with the tempo of the beats in audible music. The GUI 20 comprises graphical items such as a background 22, a battery life indicator 24 and a number of graphical menu items 26A, 26B, 26C and 26D.

The FIGS. 2A to 2C illustrates images of a GUI 20 captured sequentially while the appearance of the GUI changes in response to and in synchronisation with the tempo of the audible music. In this embodiment, the graphical menu item 26A is animated. It pulsates in size with the beat of the music. The graphical menu item 26A has the same size S1 in FIGS. 2A and 2C but has an increased size S2 in FIG. 2B. The FIGS. 2A and 2C illustrate the graphical menu item 26A at its minimum size S1 and the FIG. 2C illustrates it at its maximum size S2.

FIG. 3A illustrates how the size of the graphical menu item 26A varies when the audible music has a slow tempo. FIG. 3B illustrates how the size of the graphical menu item 26A varies when the audible music has a faster tempo.

The GUI database 12 stores a plurality of independent GUI models as independent data structures 13.

A GUI model defines a particular GUI 20 and, if the GUI 20 adapts automatically to audible music, it defines how the GUI adapts with musical time.

For example, the adaptable GUI illustrated in FIGS. 2 and 3 would be defined by a single GUI model. This model would define what aspects of the GUI 20 change in musical time. In this case the graphical symbol 26A varies between a size S1 and S2 with the tempo of the music.

A GUI model for an automatically adaptable GUI consequently defines an ordered sequence of GUI configurations that are adopted at a rate determined by the beat of the music. A configuration is the collection of the graphical items forming the GUI 20 and their visual attributes. Thus, the GUI model defines how the graphical items and their visual attributes change with musical time.

The graphical items, will be different for each GUI 20, but may include, for example, indicators (e.g. battery life remaining, received signal strength, volume, etc), items (such as menu entries, icons or buttons) for selection by a user, a background and images.

The visual attributes may include one or more of: the position(s) of one or more graphical items; the size(s) of one or more graphical items; the shape(s) of one or more graphical items; the color of one or more graphical items; a color palette; the animation of one or more graphical items such as the fluttering of a graphical menu item like a flag in time with the music.

Consequently, it will be appreciated that FIGS. 2 and 3 are simple examples provided for the purpose of illustrating the concept of embodiments of the invention and that other implementation may be significantly different and/or more complex.

For example, the background may fade in and out with the tempo of the music and/or the color palette used for the graphical user interface may vary with the tempo of the music.

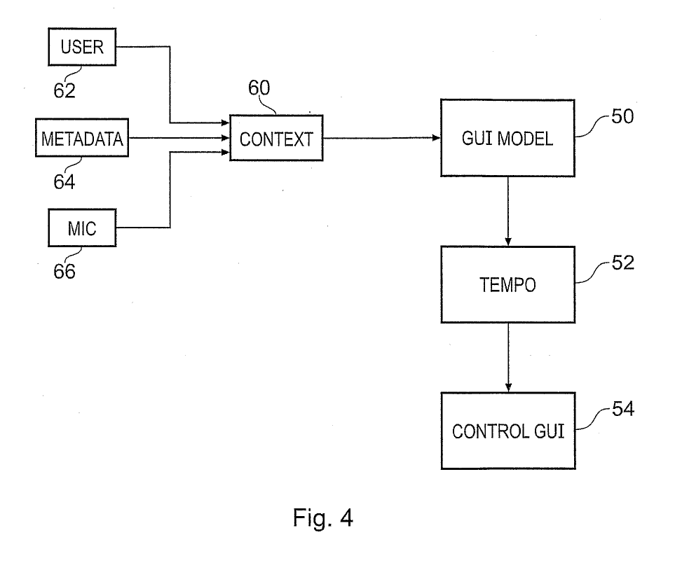

FIG. 4 illustrates a method of generating a GUI that changes in response to audible music.

The selection of the current GUI model is schematically illustrated at block 50 in FIG. 4. The selection may be based upon current context information 60.

The context information may be, for example, a user input command 62 that selects or specifies the current GUI model.

The selection may be alternatively automatic, that is, without user intervention.

The context information may be, for example, music information such as metadata 64 provided with the music track that is being played or derived by processing the audible music. This metadata may indicate characteristics of the music such as, for example, the music genre, keywords from the lyrics, time signature, mood (danceable, romantic) etc. The automatic selection of the current GUI mode may be based on the metadata.

The context information may be, for example, environmental music information that is detected from radio or sound waves in the environment of the system 10. For example, it may be metadata derived by processing ambient audible music detected via a microphone 66. This metadata may indicate characteristics of the music such as, for example, the music genre, keywords from the lyrics detected using voice recognition, time signature etc. The automatic selection of the current GUI model may be based on the metadata.

At step 52, music information that is dependent upon a characteristic of the music, such as the tempo of the music track, is obtained. The tempo is typically in the form of beats per minute. The music tempo may be provided with the music track as metadata, derived from the music or input by the user. Derivation of the music tempo is suitable when the music is produced from a stored music track and also when the music is ambient music produced by a third party.

The tempo information can be derived automatically using digital signal processing techniques. There are known solutions for extracting beat information from an acoustic signal, e.g.
Goto [Goto, M., Muraoka, Y. (1994). “A Beat Tracking System for Acoustic Signals of Music,” Proceedings of ACM International Conference on Multimedia, San Francisco, Calif., USA, p. 365-372.],
Klapuri [Klapuri, A. P., Eronen, A. J., Astola, J. T. (2006). “Analysis of the meter of acoustic musical signals,” IEEE Transactions on Audio, Speech, and Language Processing 14(1), p. 342-355.]
Seppänen [Seppänen, J., Computational models of musical meter recognition, M. Sc. thesis, TUT 2001]
Scheirer [Scheirer, E. D. (1998). “Tempo and beat analysis of acoustic musical signals,” Journal of the Acoustic Society of America 103(1), p. 588-601.].

At step 54, the processor 2 uses the music tempo obtained in step 54 and the current GUI model to control the GUI 20 displayed on display 4. The GUI 40 changes its appearance in time with the audible music. The appearance of the GUI may be changed with successive beats of the audible music in a manner defined by the current GUI model.

Each GUI model data structure 13 may be transferable independently into and out of the database 12. A data structure 13 can, for example, be downloaded from a web-site, uploaded to a website, transferred from one device or storage device to another etc. Each GUI model data structure 13 and therefore each GUI model is therefore independently portable. A common standard model may be used as a basis for each GUI model. That is, there is a semantic convention for specifying the GUI attributes.

A new GUI model can be created by a user by creating a new GUI model data structure 13 and storing it in the GUI model database 12.

Also, an existing GUI model may be varied by editing the existing GUI model data structure 13 for that GUI model and saving the new data structure in the GUI model database 12.

A GUI model data structure 13 for use with a music track may be provided with that music track.

Optionally, at step 52, information other than the tempo of the music track can be obtained. This may include for example the pitch, which can be accomplished using methods presented in the literature, e.g. A. de Cheveigne and H. Kawahara, “YIN, a fundamental frequency estimator for speech and music,” J. Acoust. Soc. Am., vol. 111, pp. 1917-1930, April 2002, or Matti P. Ryynanen and Anssi Klapuri: “POLYPHONIC MUSIC TRANSCRIPTION USING NOTE EVENT MODELING”, Proc. IEEE Workshop on Applications of Signal Processing to Audio and Acoustics, Oct. 16-19, 2005, New Paltz, N. Y. For example, the color of a GUI element may be adapted according to the pitch, e.g. such that the color changes from blue to red when the pitch of the music increases.

A filter bank may be used to divide the music spectrum into N bands, and analyze the energy in each band. As an example, the energies and energy changes in different bands can be detected and produced as musical information for use at step 54. For example, the spectrum can be divided into three bands and the energies in each can be used to control the amount of red, blue, and green color in a GUI element or background.

The musical information may identify different instruments. Essid, Richard, David, “Instrument Recognition in polyphonic music”, In Proc. IEEE Int. Conference on Acoustics, Speech, and Signal Processing 2005, provides a method for recognizing the presence of different musical instruments. For example, detecting the presence of an electric guitar may make an Ul element ripple, creating an illusion as if the distortion of the guitar sound would distort the graphical element.

The musical information may identify music harmony and tonality: Gomez, Herrera: “Automatic Extraction of Tonal Metadata from Polyphonic Audio Recordings”, AES 25th International Conference, London, United Kingdom, 2004 Jun. 17-19, provides a method for identifying music harmony and tonality. For example, the GUI model might define that certain chords of the music are mapped to different colors.

The GUI could also be adapted according to the characteristics of the sound coming from the microphone. For example, the GUI elements can be made to ripple according to the volume of the sound recorded with the microphone. Thus, if there are loud noises in the environment of the device then the loud noises can e.g. cause the GUI elements to ripple. In this case the music player of the device is not playing anything, but the device just analyzes the incoming audio being recorded with the microphone, and uses the audio characteristics to control the appearance of the GUI items.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
obtaining music information that defines at least one characteristic of audible music; and
controlling changes to an appearance of a graphical user interface using the music information by changing the appearance of a graphical menu item, wherein the graphical menu item enables access to functions of an apparatus.

2. A method as claimed in claim 1, wherein the music information is metadata for the audible music.

3. A method as claimed in claim 1, wherein the music information is obtained by processing the audible music.

4. A method as claimed in claim 1, wherein the music information is temporal information which is used to control how the appearance of the graphical user interface changes with time.

5. A method as claimed in claim 1, wherein the music information defines the tempo of beats for the audible music.

6. A method as claimed in claim 1 further comprising: storing a data structure that defines at least how the graphical user interface changes and changing with successive beats of the audible music, the appearance of the graphical user interface using the data structure.

7. A method as claimed in claim 6, wherein the data structure is selected from a plurality of data structures each of which defines how a different graphical user interface changes.

8. A method as claimed in claim 7, wherein each data structure has a standard format that enables the exchange of one data structure with another data structure.

9. A method as claimed in claim 6, wherein the data structure is portable.

10. A method as claimed in claim 6, wherein the data structure is editable by a user.

11. A method as claimed in claim 6, wherein the data structure defines an ordered sequence of graphical user interface configurations.

12. A method as claimed in claim 6, wherein the data structure is received with a music track that is used to produce the audible music.

13. A computer readable memory stored with instructions which when executed by a processor performs the method of claim 1.

14. An apparatus comprising:
a display configured to provide a graphical user interface comprising a graphical menu item where the graphical menu item is configured to enable a user to access functions of the system; and
a processor configured to obtain music information that defines at least one characteristic of audible music and configured to control changes to an appearance of the graphical user interface by changing the appearance of a graphical menu item using the music information while the music is audible.

15. A mobile cellular telephone comprising the apparatus of claim 14.

16. A mobile music player comprising the apparatus of claim 14.

17. (canceled)

18. A method comprising:
storing a data structure that defines at least how a graphical user interface changes and changing with successive beats of audible music, the appearance of the graphical user interface using the data structure by changing the appearance of a graphical menu item, wherein the graphical menu item enables access to functions of an apparatus.

19. An apparatus as claimed in claim 14 wherein the music information defines the tempo of beats for the audible music.

20. A computer readable memory as claimed in claim 13 wherein the music information defines the tempo of beats for the audible music.

21. A method as claimed in claim 18 wherein the music information defines the tempo of beats for the audible music.

22. An apparatus comprising:
means for obtaining music information that defines at least one characteristic of audible music; and
means for controlling changes to an appearance of a graphical user interface using the music information by changing the appearance of a graphical menu item, wherein the graphical menu item enables access to functions of an apparatus.
